(19) United States
(12) Patent Application Publication
(10) Pub. No.: US 2013/0144753 A1
(43) Pub. Date: Jun. 6, 2013

(54) E-COMMERCE METHOD AND SYSTEM

(71) Applicant: George Moser, Redwood City, CA (US)

(72) Inventor: George Moser, Redwood City, CA (US)

(21) Appl. No.: 13/310,794

(22) Filed: Dec. 4, 2011

(51) Int. Cl. G06Q 20/12; G06Q 30/06

(52) U.S. Cl. 705/26.35

(57) ABSTRACT

An improved ecommerce system and process for conducting transactions is provided. The system holds a buyer's payment until the buyer has an opportunity to object to the goods or services provided. Payment is released to the seller if a complaint is not submitted within a buyer grace period. If a complaint is submitted, the system facilitates thorough communications between buyer and seller, and provides for dispute resolution. In some embodiments, a request-for-quote operation can be provided, as well as implementation of credit terms and automated generation of commercial transaction documents.

### FIELD OF THE INVENTION

The invention is in the field of computer-based electronic commerce methods and systems, particularly those relying on the Internet.

### STATE OF THE ART

E-commerce has achieved a substantial level of success, with billions of dollars being traded on-line through the Internet every year. The company that has been most successful in this area so far has been eBay.

However, a large part of the market remains untapped, in part because of the methodology used by current e-commerce companies including eBay. This methodology is based on having the buyer pay upfront, before receiving the merchandise being purchased. After receiving full payment, the buyer ships the merchandise to the buyer. If the merchandise fits the description and condition of the items offered, that concludes the transaction. However, if the buyer is dissatisfied with the items, a resolution process starts that can take weeks or months and which is made especially difficult because the buyer has no leverage, since the merchandise is already paid in full.

The lengthy and difficult resolution process leads to many buyers giving up on their complaint and just accepting the loss, therefore getting stuck with an item they don't like. These buyers become reluctant to buy online again.

Many potential buyers are reluctant to buy online in the first place, because it is a well-known fact that the current system disproportionately favors the seller over the buyer, because upfront full payment before shipment gives the seller too much leverage. Reputable sellers don't take advantage of this bias in the system, but the Internet includes millions of potential sellers, some reputable and many who are not. The buyer in many cases doesn't know what type of company or individual he/she is buying from, and he/she may perceive the transaction as too risky—and not order online.

There have been some attempts to design an ecommerce system that would address the issue of current bias in favor of the seller. U.S. Pat. No. 7,734,320 proposes an escrow system, which is an improvement, but it is based on an inspection system where the buyer is required to go inspect the items upon delivery to a local warehouse before releasing payment. Such a system would be impractical, too expensive and not acceptable to most users because of the hassle of having to travel to inspect items.

U.S. Pat. No. 8,051,150 tries to address the reluctance of many potential online buyers to order online by having a website acting as an intermediary in the transaction and hiding the identity of the parties to the transaction from each other to avoid disclosure of sensitive financial information, such as credit card number or bank account numbers. However such a system does not address the bias in favor of the seller created by the approach of having the buyer pay full price upfront before shipping.

Another unintended consequence of the current system is that buyers tend not to use e-commerce for large purchases, because of the risk involved. That risk is generally perceived as acceptable for a small ticket item such as a $5 book, but for a $50,000 item it would seem too risky to most potential buyers, since the resolution of a possible dispute is potentially very difficult because of the “full pay upfront” approach.

The current pay upfront approach also takes the incentive away from sellers to ship the merchandise as quickly as possible and to package it correctly. The transaction is already done and the seller is already paid.

Another problem for many potential buyers is that typically current e-commerce sites such as eBay use the auction approach, which means that even if the desired item is found, it may not be available for several days. That is OK for some items, but most buyers would prefer to find what they want and order it without having to wait for the end of an auction. A so-call “buy it now” option is available for some items, but the majority of items are subject to the auction waiting period. Most people don't have the time or inclination to engage in an auction and wait a relatively long time for an item they want right away.

Another problem with the current system is that the site facilities provided to show the items for sale are not advanced enough, relying basically just on photographs of the item posted on the site. Photographs are useful, but more advanced systems can be helpful, because a photograph can show the item only from the most favorable side/angle. The site should provide the necessary facilities for multiple photographs in an interactive session with the seller, video, audio, as well as support for smartphones, laptops and tablets for a live demonstration of the item for sale. The communication between seller and buyer should be enhanced by providing messaging, instant messaging, email, voice over Internet Protocol (VOIP), video conferencing, twitter-like messaging and other facilities that can make it easy and fast for buyer and seller to pursue the desired transaction. For long distance transactions, VOIP can be particularly useful to avoid the deterrence of long distance phone costs.

The previously mentioned facilities for communication and for display of the items can be particularly important because it can create the level of comfort and trust needed for a transaction between parties still unknown to each other. In many cases this method also can create a record that can be used to prove that the part displayed and the part shipped are actually the same.

A further problem of current e-commerce systems is that they don't support terms of credit, such as net 30, net 60 or other terms that are customary in commercial transactions. That is a very serious limitation, because the vast majority of commercial transactions are based on such credit terms. Current systems support only cash or credit card purchases (or variations thereof such as PayPal), but they do not support credit terms. There is an enormous market that is currently excluded from e-commerce by not supporting credit term transactions. The size of the unserved credit term market is a multiple of the size of the market that is currently served by current systems.

Another problem with the current e-commerce system is that it discourages international transactions. The “pay upfront in full” approach works in many cases for small ticket items within the national borders, but for transactions involving a seller abroad the risk is generally perceived as too high. That virtually eliminates most international sources that otherwise could be highly competitive or even better in some categories. That is a disadvantage for both sellers and buyers. The excessive bias of the current system in favor of the seller ends up hurting sellers trying to sell their items into other countries, by virtually eliminating them from consideration. That includes not only Asian sellers trying to sell in the U.S. and Europe, but also American sellers trying to sell globally. The current system bias is to everybody's disadvantage.

An unbiased system that equally protects buyers and sellers would open up huge new markets for e-commerce, both nationally (more buyers because of more trust in the system, and also addition of bigger ticket items) and internationally (complete new continents with billions of buyers would be added to e-commerce).

### BRIEF DESCRIPTION OF THE DRAWINGS

FIGS. 1-3 are flowcharts of a prior art process for conducting an ecommerce transaction.

FIGS. 4-6 are flowcharts of a process for conducting an ecommerce transaction in accordance with an embodiment of the invention.

FIGS. 7-10 are flowcharts of a process for conducting a commercial ecommerce transaction with a request-for-quote process and optionally credit terms, in accordance with another embodiment of the invention.

### DETAILED DESCRIPTION OF THE DRAWINGS

While this invention is susceptible to embodiment in many different forms, there are described in detail herein several specific embodiments, with the understanding that the present disclosure is to be considered as an exemplification of the principles of the invention and is not intended to limit the invention to the embodiments illustrated.

The embodiments illustrated herein describe a new system and method to conduct e-commerce that eliminates biases in current systems and ensures that both buyer and seller are equally or similarly protected, which is in the interest of both buyers and sellers to the extent it serves to dramatically expand the size of the e-commerce market. The new system will also enable credit term based transactions (further expanding the e-commerce market size) and enable and popularize international e-commerce to an extent not experienced until today.

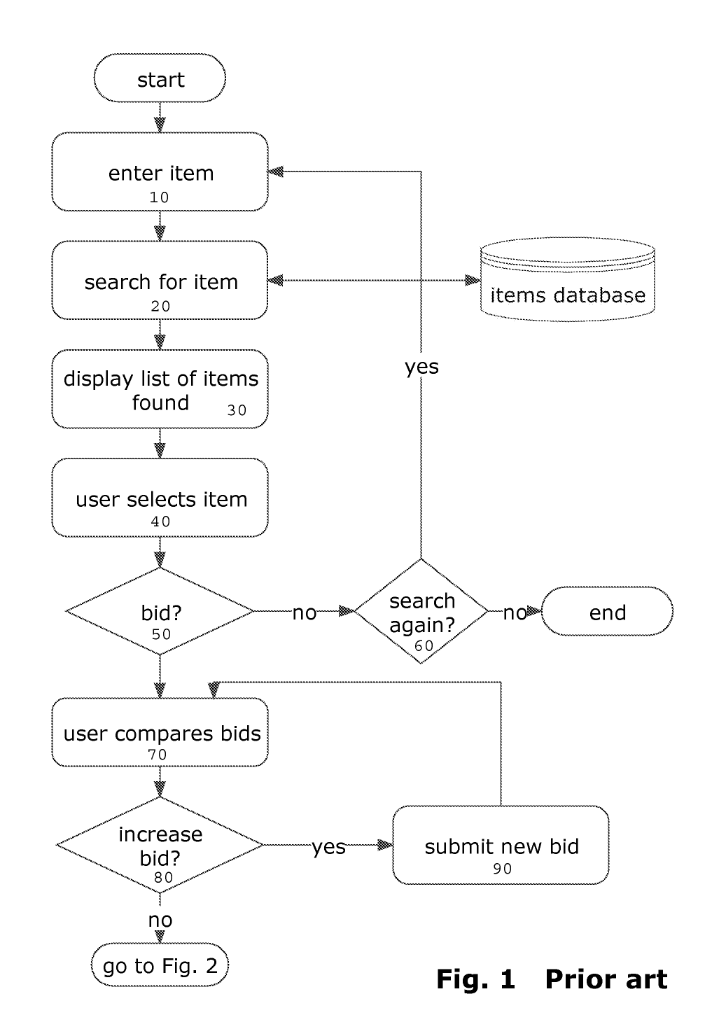

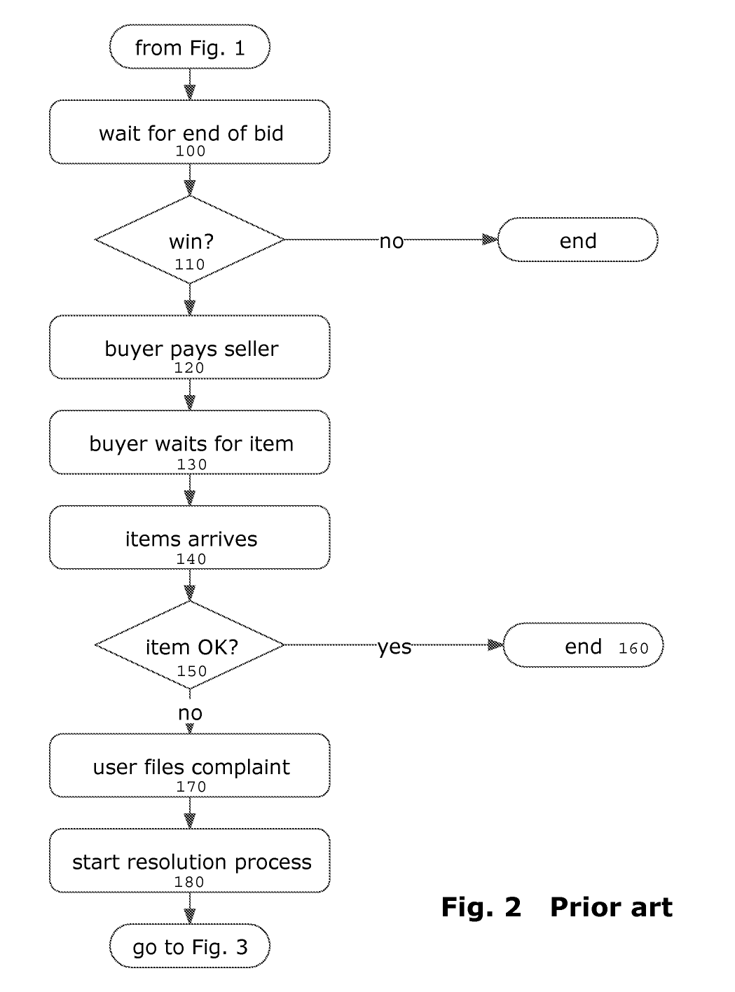

FIGS. 1 and 2 show a conventional prior art e-commerce system. The flow of the transaction is as follows:
The buyer enters the name of the item (or the category of items) (step 10);
the system conducts a search for the item in the system database, which contains the items that are offered for sale by registered sellers (step 20)
the system displays the matching items found in the system database (step 30)
the buyer selects the items that look interesting, reads the descriptions, views the photos displayed and then selects the most likely item (step 40);
The buyer decides whether or not to bid for the item selected (step 50);
If the decision is not to bid, the buyer can decide whether to start a new search for the same or another item (step 60);
If the user decides to bid, the system enters the bid and allows the user to compare his bid to other bids (step 70);
based on the previous comparison, the user may decide (step 80) to either a) submit a new bid for a higher amount (step 90), or b) await the end of the bid (and potentially submit a new bid near the end of the auction) (step 100, FIG. 2).
when the auction ends at a pre-defined time, the site notifies the winner of the auction and the seller (step 110);
the buyer now has to pay the full price of the item plus shipping and handling to the buyer, using a credit card or a service such as paypal (step 120);
the buyer waits for the delivery of the item (step 130);
when the item arrives (step 140), the buyer inspects the item (step 150) and either: a) is satisfied, which marks the end of a successful transaction (160), or b) files a complaint with the system (step 170) to start the dispute resolution process (step 180).

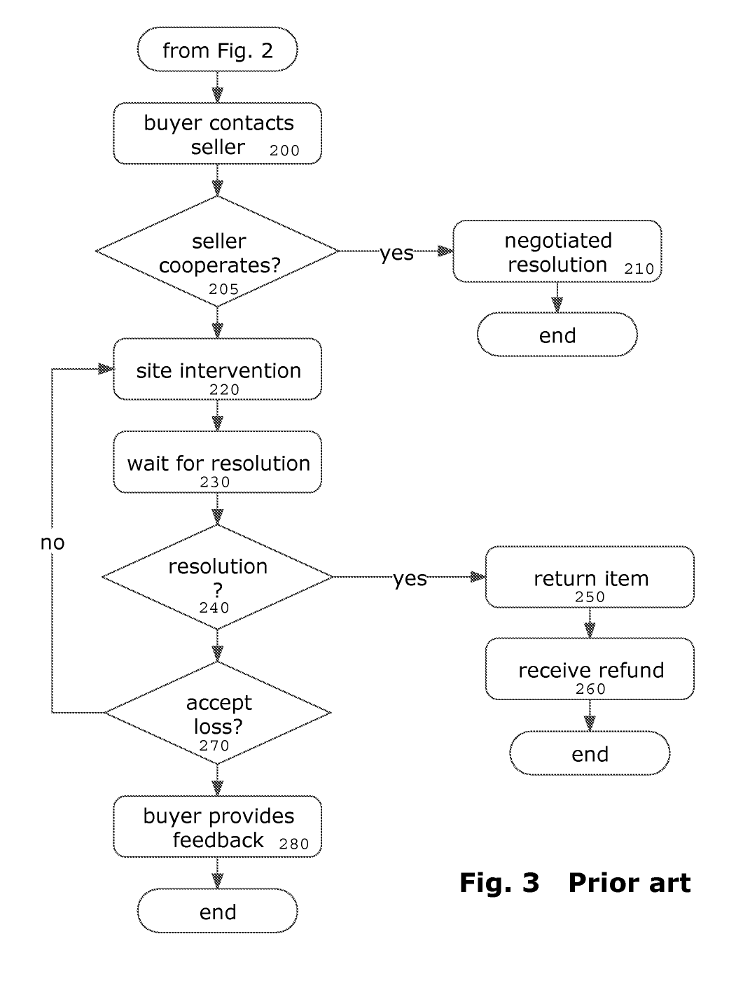

FIG. 3 shows a typical prior art dispute resolution process. The buyer is required to initially contact the seller and try to resolve the dispute on his/her own (step 200). The buyer must then determine whether the seller will be cooperative (step 205). If the seller is cooperative or the matter in dispute obvious or minor, the issue may be quickly resolved (step 210).

Unfortunately, cooperation and quick resolution by the seller often does not occur, because the seller is already paid in full and reluctant to take the item back and grant a refund. It also happens that the seller does not even respond to the contact attempts by the buyer. The only leverage the buyer at that point is the feedback that the buyer can provide regarding the seller. Reputable sellers try to maintain a good track record and therefore are generally responsive to the complaints of buyers. However, not every seller falls in that category, and the risk of having to deal with a seller in that category is high, especially if the seller is not an established vendor but rather an individual performing an occasional transaction.

If the attempts of the buyer to get resolution fail, the site can intervene and contact the seller (step 220). The buyer waits (step 230), in some cases for weeks, while the site attempts to resolve the situation. The site also has very limited leverage, because payment has already been made in full. Eventually, the site determines whether it can achieve resolution (step 240). If a resolution is reached, the item is returned (step 250) and a refund is issued (step 260). If no resolution is reached, the buyer must decide whether to accept the loss (step 270). If so, they buyer may provide negative feedback about the seller (step 280). Alternatively he/she can file an appeal with the site, which extend the process even further.

A major disadvantage of this resolution method is that it can be very lengthy and time-consuming, and puts the buyer at a great disadvantage, because the buyer may have to order the needed item again from another vendor, without even knowing if the dispute for the item already purchased will be resolved or not, and when. The buyer during this whole process is under no time pressure to get the dispute resolved because full payment has already been made.

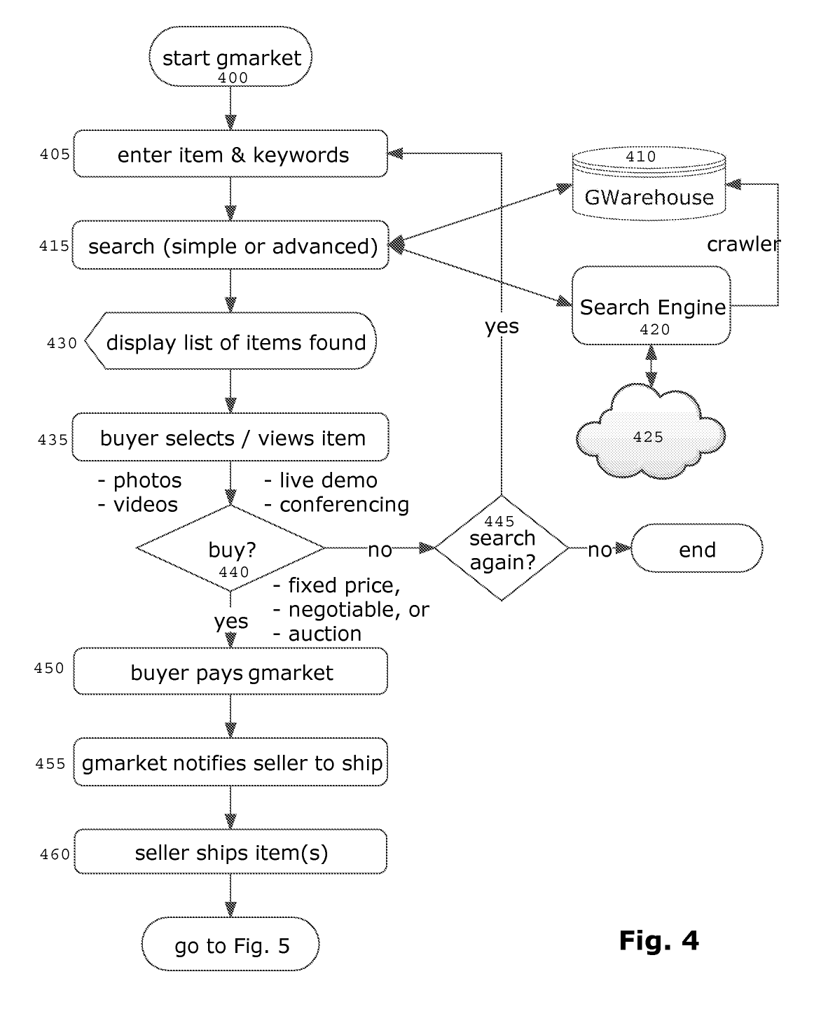

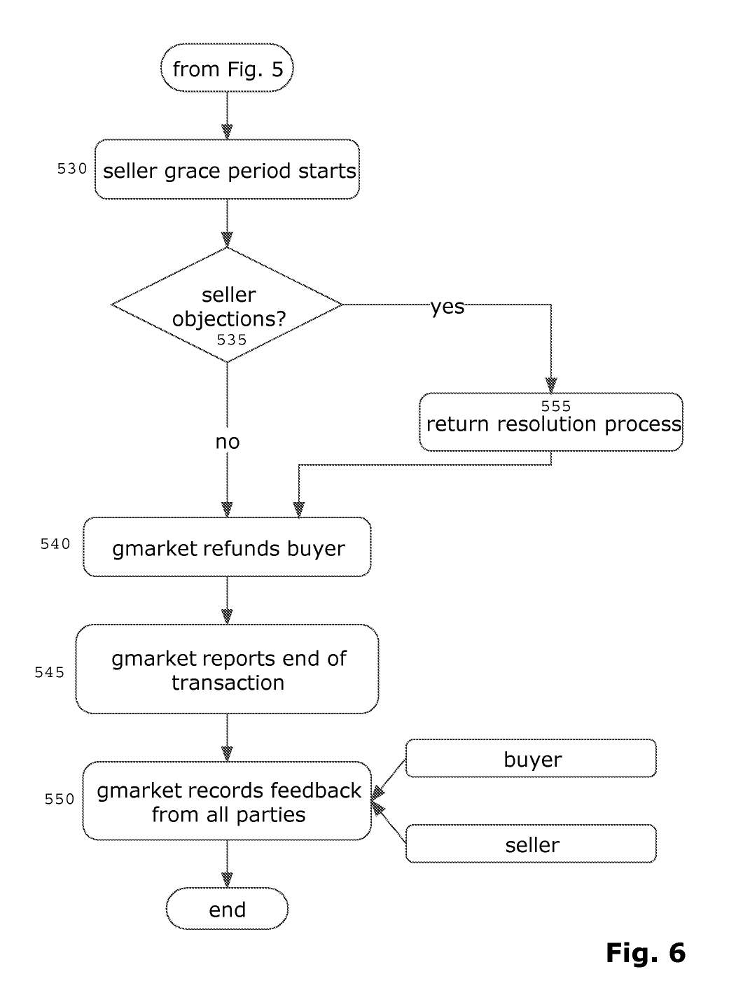

FIGS. 4-6 illustrate an embodiment of an alternative method and system for execution of a transaction via electronic commerce. In step 400, the buyer logs into a system web site (referred to hereinafter as gmarket, short for global market). The buyer enters a search term for the desired item (step 405). In addition, the buyer is allowed to enter additional keywords that can accelerate and/or focus the search (such as synonyms, characteristics or properties of the item, size/dimensions, capacity, color, item age, material, geographic location, price range, features desired, features undesired, country of origin, etc.). Whenever a seller enters an item for sale, he/she is also allowed to enter such additional keywords, which facilitates creating a match with the items being searched.

In the e-commerce system of FIG. 4, the intent is to create a giant global virtual warehouse (the Gwarehouse) where almost any item worldwide can be found. Therefore generally no listing fees will be charged and items can be “gwarehoused” for free indefinitely (a periodic email reminder, typically once a year, will ask sellers to confirm that the item is still available and for sale to keep inventory fresh and relevant, but generally no extension fees will be charged). The GWarehouse will generally exist as an organized and indexed database 410 that can exist in a physical location and/or in the cloud, or as a set of linked databases that can exist in a physical location and/or in the cloud. The GWarehouse can be segmented by countries or regions to facilitate searches, e.g. by starting searches in the more likely locations.

As the next step in FIG. 4, a search for the item is conducted (step 415). The search can be a simple search (with or without keywords) or it can be an advanced search based on specific fields of the GWarehouse database. The advanced search can be entered by the user by filling out a table with the possible search fields, or by providing a special search command language with a syntax that allows logical operators (such as for instance the syntax provided by the USPTO for searches of the USPTO database).

In order to rapidly populate and grow the Gwarehouse, the system of this invention includes a Search Engine 420 that searches the Internet 425 with crawler software for the same items being searched by buyers, in order to find sources for those items and automatically invite those sites to list in Gmarket. This is analogous to the crawler software used in search engines to collect information that will accelerate searches, but in this case it is focused on the items that buyers are looking for in their searches. The use of this crawler software will allow fast and inexpensive growth of the GWarehouse.

The user's search in step 415 returns a list of responsive items, which is displayed to the user (step 430). The buyer then selects and views the desired item (step 435). Preferably, Gmarket provides not only the traditional photos of the item, but also other communication options for conveying information about the item, such as multiple photos from many sides and angles and even videos that the seller can post in the site using the site supported recording devices which can include a digital camera, a video recorder, the built-in camera of a laptop, the camera of a tablet computer, the built-in camera of a phone or other portable or stationary recording devices. An important feature to many buyers will be the live demo, which allows a seller to walk around the item with a camera, recorder, phone, tablet or laptop and demonstrate the product from different sides and angles, possibly in operation to prove its working condition. Also, communication facilities such as messaging, instant messaging, email relaying, audio conferencing, video conferencing and other communication facilities can be provided by the site to facilitate the transaction.

Next, the buyer makes the buying decision (step 440). If negative, the buyer can choose whether to start a new search (step 445). If positive, the buyer pays Gmarket the full item price plus shipping and handling as applicable (step 450). Gmarket confirms to seller that full payment has been made and that it is OK to ship the item to the buyer (step 455). The seller ships the item (step 460).

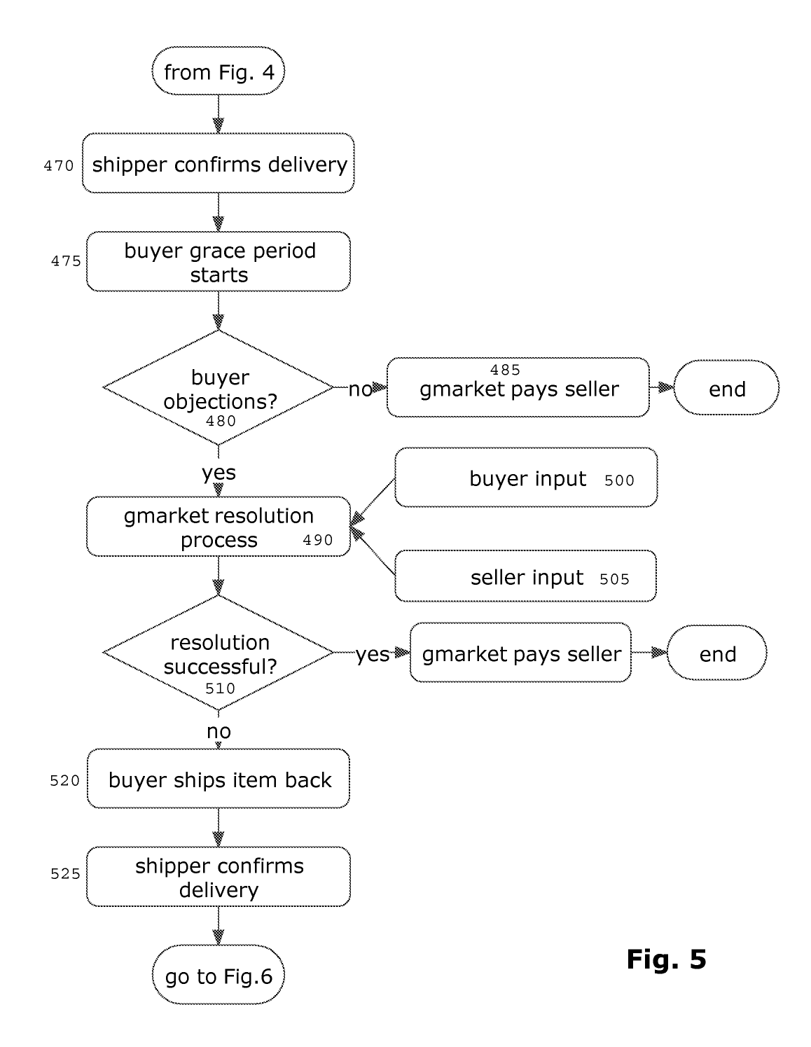

In FIG. 5, when the item arrives, the shipper confirms delivery to Gmarket (step 470). A grace period is provided for the buyer to report problems with the transaction (step 475). In the embodiment of FIG. 5, that grace period is triggered by the seller's confirmation of delivery to Gmarket. In some embodiments, the length of this grace period may vary based on factors associated with the transaction and/or the parties involved. For example, the duration of the grace period may be dependent on the dollar amount of the purchase and other factors. Typically, the determination of grace period will be part of the terms and conditions agreed by all parties at the time the purchase is made. In a typical embodiment, for a small item, the grace period may be approximately 2 business days.

A determination is then made as to whether a buy objects to the transaction before expiration of the grace period (step 480). If there are no buyer objections within the grace period, Gmarket pays the seller (step 485).

If there are objections within the grace period, the Gmarket resolution process starts (step 490) by Gmarket receiving input from both buyer (step 500) and the seller (step 505). Preferably, the Gmarket site provides communication facilities to encourage interaction between the buyer and seller to help the parties explain and understand any objections and potential resolution. For example, being able to show the product and explain the objections in a video conference can facilitate a quick resolution. In addition to video conferencing, the Gmarket site may enable exchange of photographs, video clips and written communications between the parties, in order to explain and discuss any concerns with the product or transaction.

Ultimately, a determination is made within the Gmarket site as to whether the buyer will keep the merchandise (step 510). This decision may be made by agreement of the parties. Alternatively, Gmarket may act as an arbitrator to determine whether the buyer will be forced to keep merchandise or whether the buyer will be permitted to ship merchandise back. The arbitration decision may be driven by automated rules, or may include subjective determinations based on the information submitted by the parties during the resolution process 490.

If the buyer will keep the merchandise, Gmarket pays the seller (step 515). Otherwise, the buyer ships the item back to the seller (step 520). Delivery of the item back to the seller is confirmed in step 525.

As soon as the item arrives back at the seller's location, the seller's grace period starts (step 530). The seller's grace period provides a (preferably short) period of time during which the seller can report any objections regarding the returned item. A determination is then made as to whether the seller indicates objections to the returned merchandise before expiration of the seller's grace period (step 535). If not, Gmarket refunds the buyer (step 540), closes the transaction (step 545) and records the feedback from the buyer and seller (step 550). If so, a return resolution process is initiated (step 555) during which the Gmarket service provider determines whether the returned merchandise satisfies criteria for a refund. If so, operation proceeds towards issuance of a refund to the buyer (step 540). If not, the transaction is ended without refund (step 545).

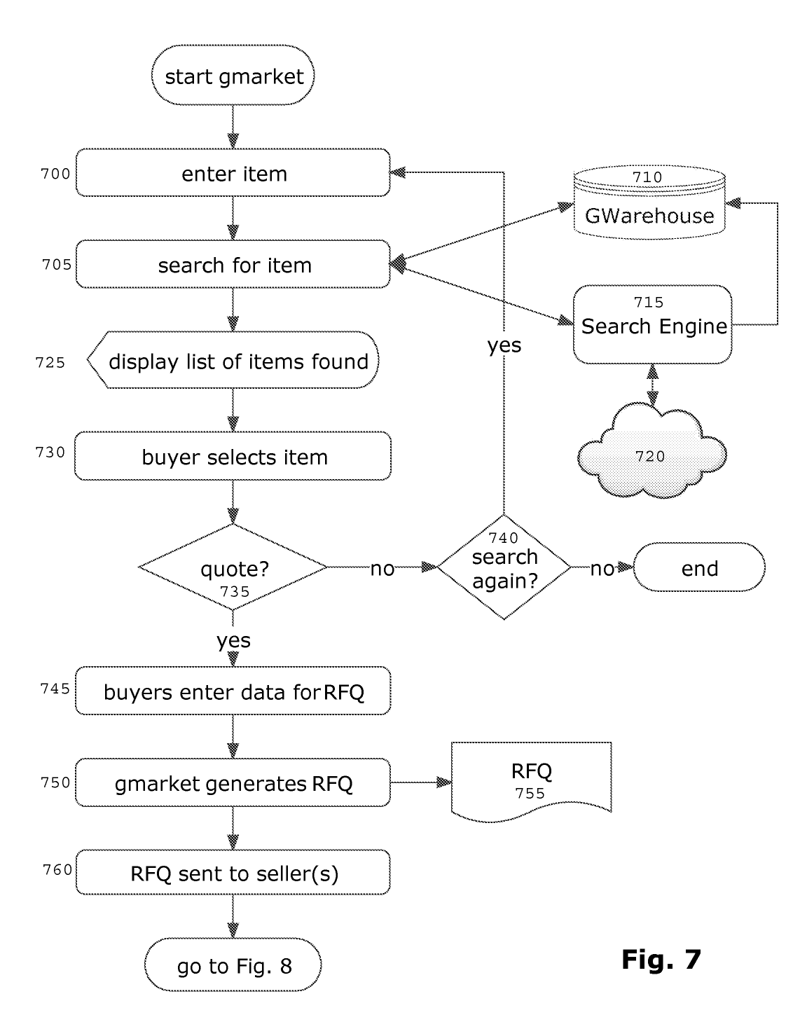

The transaction described in FIGS. 4 through 6 reflects an embodiment that may be preferably used in a transaction between individuals or between an individual and a dealer. Other a commercial transaction (typically between two companies), a modified implementation may be preferable. FIGS. 7 through 10 illustrate an alternative process and system that may be useful to conduct such commercial transactions. In some embodiments, users may be offered a choice as to whether they will use the process of FIGS. 4-6, or the alternative commercial process of FIGS. 7-10, for a given transaction. The commercial process includes the ability to accept and grant credit terms.

FIG. 7 illustrates a process for performing a commercial transaction. The initial portions of the process are analogous to initial steps in FIG. 4, previously described. The buyer enters information associated with a desired item (step 700), a search is conducted (step 705) with Gwarehouse database 710. Gwarehouse database 710 can optionally be populated through operations including the operation of search engine 715 operating on Internet 720. Responsive items are displayed to the buyer (step 725), and the buyer selects a desired item (step 730).

Once the buyer has viewed and selected an item, the buyer determines whether to request a quote on the selected item (step 735). If not, the buyer decides whether to run another search or terminate the potential transaction (step 740). If so, the buyer enters data required to prepare a Request for Quote (RFQ) (step 745). The Gmarket system operates (step 750) to generate a standardized RFQ document 755. RFQ 755 is sent to one or more seller (step 760).

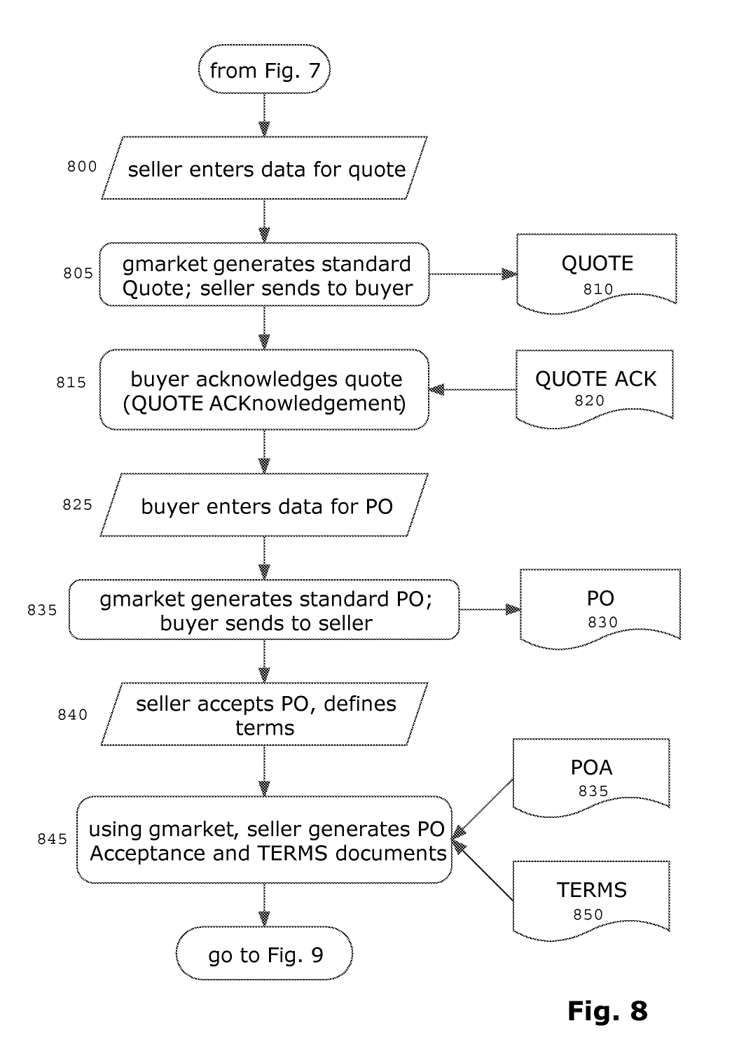

FIG. 8 shows the continuation of a Gmarket commercial process. In step 800, one or more sellers respond to RFQ 755 by entering data for a quote (step 800). The Gmarket system utilizes information entered in step 800 to prepare standard commercial transaction documents, such as the Quote (QUOTE 810), the Quote Acknowledgement (QUOTE ACK 820), the Purchase Order (PO 830), the Purchase Order Acceptance (POA 835) and the terms document (TERMS 850). Specifically, QUOTE 810 is generated in step 805 and transmitted to the buyer. In step 815, QUOTE ACK 820 is generated in response to the buyer's acknowledgement of QUOTE 810. The buyer then enters purchase order data into the Gmarket system (step 825). The Gmarket system then generates PO 830 and transmits that document to the seller (step 835). In step 840, the seller accepts PO 830 and defines transaction terms. The Gmarket system is then utilized by the seller to generate POA 835 and TERMS 850. Preferably, the commercial transaction documents are standardized to enable an efficient and largely automated generation and processing of these transaction milestones.

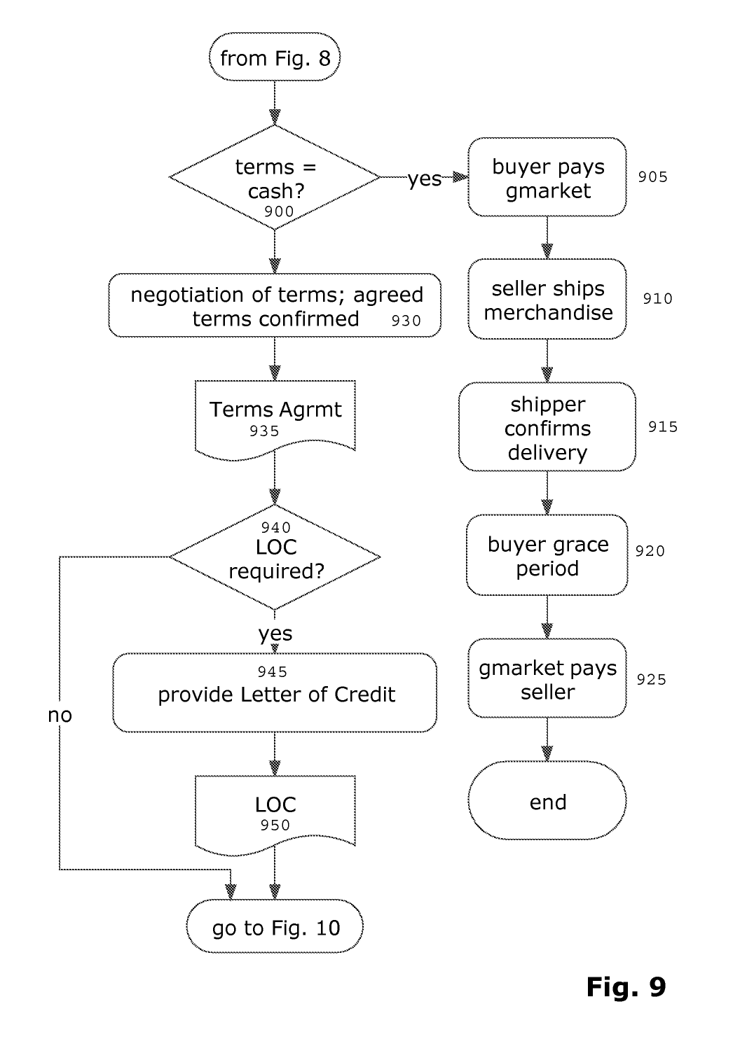

FIG. 9 shows that depending on the terms, the transaction can follow two paths, depending on whether the terms will be cash or credit (step 900):

If the terms are cash, the right hand path is followed with the same steps described in connection with the embodiment of FIGS. 4-6, which include payment to Gmarket (step 905), shipping to buyer (step 910), delivery confirmation by shipper (step 915), grace period(s) (step 920) and payment to seller by Gmarket (step 925). Preferably, if disputes arise, dispute resolution processes described in connection with the embodiment of FIGS. 4-6 can also be employed.

If the terms are credit, then credit terms can be negotiated and agreed upon between the parties, preferably facilitated through the Gmarket web site (step 930). A Terms Agreement 935 is generated. In step 940, a determination is made as to whether a Letter of Credit (LOC) is required. If so, LOC 950 is provided by a financial institution (step 945).

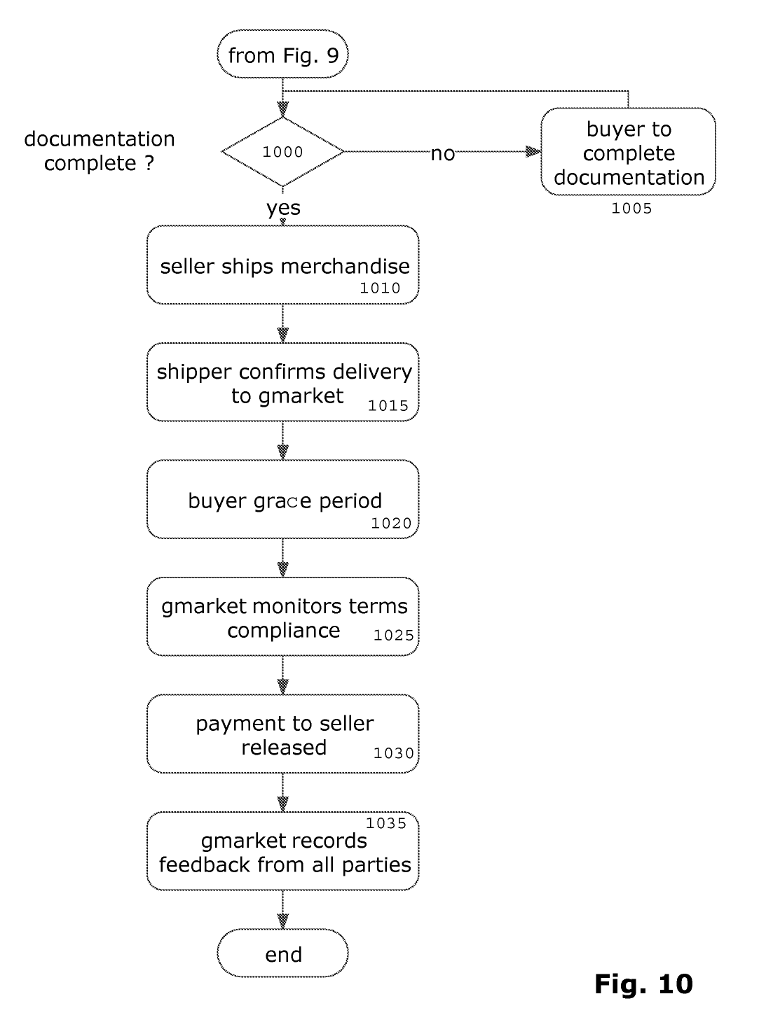

In step 1000 (FIG. 10), a determination is made as to whether the transaction documentation is complete. If not, the buyer is required to complete the documentation (step 1005). However, if the documentation is complete, then the seller ships the merchandise (step 1010). Delivery of the merchandise is confirmed with Gmarket (step 1015), which initiates a buyer grace period (step 1020). During the buyer grace period, the Gmarket system monitors compliance with the terms of the transaction, which may include a period for buyer inspection and approval and/or other terms conditioning acceptance of the merchandise and completion of the transaction. If the transaction terms are satisfied, payment is released to the seller (step 1030), and the Gmarket system provides an opportunity for all parties to record feedback regarding the transaction (step 1035).

An instructional screen that can be made available to users to explain the operation of the system and method. A detailed view of an item returned within a search result, includes a buy button operable for selection of an item in step 435. The system can further include access to multiple communication options to convey information about the selected item, such as a photo gallery, a video clip, a video conferencing system to enable live audiovisual communication between the parties, and email communication. A user can submit a bid for an item (step 440). A user interface provides confirmation of bid acceptance. Confirmation of a buyer's payment following step 450 can be provided. Notice to a seller that an item has been sold and request for shipment in connection with step 455 can be provided.

A notification to the buyer than an order has been delivered (step 470, FIG. 5) and that a buyer's grace period is commencing (step 475). A message is provided to a buyer if no timely objection is made, upon which payment is released to the seller in step 485. Upon approval of a buyer complaint in step 510, and requesting return shipment of the goods in step 520, the buyer is provided with a notice, while the seller is provided with a notice. Upon confirmation of return shipment in step 525, a notice is provided to the seller. If the seller does not object to the return shipment in step 535, a notice is provided. Upon refund issuance to a buyer in step 540, a notice is provided. The user interface provides an opportunity for submission of buyer feedback in step 550, while the user interface provides an opportunity for submission of seller feedback.

It is important to note that the procurement system, methods and implementation illustrated herein can be beneficially utilized for procurement of not only physical goods, but also to services. Preferably, software and systems will be configured to enable transactions for services as well.

An exemplary system for implementing the above-described processes and user interactions is also provided. Users (which may include both buyers and sellers) access the Gmarket system via Internet. The Gmarket system includes a web server, which presents the Gmarket user interface to users via Internet. Gmarket system software, implemented on a computer system, operates to execute the processes and operations described above, including but not limited to functionality supporting the steps in FIGS. 4-10, as well as presentation of the user interface displays. The system software operates to access a number of databases containing information required for implementation of the above-described Gmarket system.

An electronic warehouse database contains information describing items available for sale using the system. A transaction database contains information relating to transactions being conducted on the system. A buyer information database contains account information for users of the system seeking to make purchases. A seller information database contains account information for users of the system seeking to sell items. Another database contains other information to support the above-described operation, processes and user interface.

The foregoing description and drawings merely explain and illustrate the invention and the invention is not limited thereto except insofar as the appended claims are so limited, as those skilled in the art who have the disclosure before them will be able to make modifications and variations therein without departing from the scope of the invention.

1-20. (canceled)

21. A computer-implemented method for conducting a purchase transaction via the Internet, comprising the steps of:
Identifying by a buyer a desired item from amongst a plurality of items listed on a centralized computer system accessible via the Internet, the centralized computer system aggregating items available for purchase from a plurality of sellers;
exchanging between the buyer and a seller of the desired item, information describing the desired item via one or more communication facilities implemented via the centralized system;
making a payment by the buyer for the desired item to the centralized system;
communicating order details from the centralized system to the seller of the desired item;
starting a first grace period upon confirming delivery of the desired item to the buyer;
releasing the payment from the centralized system to the seller of the desired item upon expiration of the first grace period without the buyer notifying the centralized system of an objection with the transaction.

22. The method of claim 21, further comprising the steps of:
receiving by the centralized system, during the first grace period, a notification that the buyer objects to the transaction;
initiating a dispute resolution process by the centralized system, during which said information exchanged between the buyer and the seller of the desired item via said one or more communication facilities is utilized to evaluate the merits of the objection.

23. The method of claim 22, further comprising the steps of:
determining by the centralized system that the buyer is entitled to return the purchased item;
initiating a second grace period during which the buyer can return the purchased item;
releasing the payment from the centralized system to the buyer upon receipt by the centralized system of confirmation that the purchased item has been returned to the seller during said second grace period;
releasing the payment from the centralized system to the seller upon determination that the purchased item has not been returned to the seller during said second grace period.

24. The method of claim 21, in which the step of viewing by the buyer information describing the desired item via one or more communication facilities is further comprised of the step of viewing by the buyer information describing the desired item via one or more of text messaging, videoconferencing and audioconferencing.
